(19) United States
(12) Patent Application Publication
(10) Pub. No.: US 2026/0307640 A1
(43) Pub. Date: Oct. 8, 2026

(54) METHOD FOR CONTROLLING A BRAKE SYSTEM OF A MOTOR VEHICLE WITH INCREASED SAFETY REQUIREMENTS

(71) Applicant: AUMOVIO Germany GmbH, Frankfurt am Main (DE)

(72) Inventors: Tom Kaufmann, Ippenschied (DE); Bogdan Budianu, Oberursel (DE); Sebastian Kuhn, Hofheim (DE); Rüdiger Puff, Hünstetten-Wallbach (DE); Salah Elddin Sadek, Griesheim (DE); Felix Alexander Fertig, Frankfurt am Main (DE); Eberhard Münz, Sandhausen (DE); Michael Doericht, Kelkheim (DE)

(73) Assignee: AUMOVIO Germany GmbH, Frankfurt am Main (DE)

(21) Appl. No.: 19/637,114

(22) Filed: Apr. 2, 2026

(30) Foreign Application Priority Data
Apr. 2, 2025 (DE) 10 2025 112 918.5
Jun. 24, 2025 (DE) 10 2025 124 276.3

(51) Int. Cl. B60T 17/22; B60T 13/74

(52) U.S. Cl. CPC B60T 17/221; B60T 13/745; B60T 2270/402; B60T 2270/403; B60T 2270/406

(57) ABSTRACT

A brake system and a method for controlling a brake system of a motor vehicle having an electronically commutated electric machine comprises controlling the electric machine in a normal operating mode, wherein a current rotor position of the electric machine is determined using a rotor position sensor; checking functionality of the rotor position sensor; checking whether a first test condition is met upon detection of a sensor error; changing from the normal operating mode into a safety operating mode when the first test condition is met; controlling the brake system in the safety operating mode; checking whether a second test condition is met in the safety operating mode; controlling in the safety operating mode when the second test condition is met; changing to a fallback operating mode when the second test condition is not met; and controlling the brake system in the fallback operating mode.

### TECHNICAL FIELD

The present embodiments relate to a method for controlling a brake system of a motor vehicle and to an electronically commutated electric machine of the brake system, and to a brake system for a motor vehicle comprising such an electric machine.

### BACKGROUND

In modern motor vehicles, electronically commutated electric machines are used, for example, as permanent excited syncronous machines (PMSM). The electric machine may comprise a stator and a rotor, wherein the rotor is mounted in the stator. Such electric machines are generally supplied with energy via energy stores internal to the vehicle that provide a direct voltage. A multiphase, usually three-phase output current can be generated by means of a power converter (for example a B6 bridge), which output current can be fed to the stator coils of the electric machine in order to generate a rotating rotary magnetic field by means of which the rotor can be made to rotate. The rotor may accordingly be designed to be permanently excited. The phases of the three-phase current generated by the power converter and of the associated rotating field are also referred to as motor phases in this case.

Field-oriented current regulators can be used for control and regulation, this is also referred to as vector control. Such current regulators require the current rotor position, usually obtained from a suitable sensor for determining the same. For this purpose, the currents are transmitted by means of the present rotor position into the rotating reference frame of the rotor, thus resulting in a field-weakening d current and a torque-generating q current which can be easily controlled.

For determining the current rotor position, rotary position measuring systems are available which make it possible to determine the orientation or the rotor position of the rotor within the stator. Corresponding rotor position sensors may be used to measure rotor position signals. The contact systems used in these rotary position sensors generally assume an uninterrupted electrical contacting, such that the control reliably functions. When using rotor position sensors, however, it is possible that correspondingly required contact systems, for instance under particular loads such as high temperatures or on account of mechanical stresses in components, dynamic influences or due to aging phenomena, lead to electrical contacting in the case of which short-term resistance fluctuations or even contact interruptions cannot be completely ruled out, so that under certain circumstances at least temporarily there are no longer any sensor signals for determining the rotor position or the sensor signals are falsified.

For control of the electric machine in relation to its drive torque and the resulting speed or position, it is however important to know the exact rotor position or rotor orientation in order to be able to correspondingly control the output current of the phases or to be able to supply the motor phases with current at the correct time.

Known possibilities for operating an electric machine without rotor position information from a rotor position sensor are controlling by specifying a rotating stator field in a so-called rotating field operation, or using field-oriented motor control on the basis of a position signal from the calculated mutual induction voltages of the motor phases. Methods based thereon are known as BEMF methods (BEMF = "back electromotive force"), wherein induced voltage signals can be detected as a result of a back electromotive force. Due to the weaknesses of the angle calculation from a BEMF method at low rotation speeds, a combination of a BEMF method and a specification-controlled rotary field operation is often used.

In turn, here the specification-controlled rotary field operation is suitable for the operation of such an electric machine only to a limited extent. In the case of dynamically fluctuating load situations difficulties arise since there is the risk that the rotor cannot follow the applied rotating field and thus falls "out of step." Various influences such as undervoltage pulses or sudden changes in load can also cause the motor to "fall out of step." Also during the activation of the stator field when the rotor rotation speed is unknown, situations may occur in which the rotor cannot always follow the rotating field.

In safety-relevant applications of such electric machines, it may however be necessary for the regulation to be able to place the electric machine into an emergency operation or into a safety mode even if sensor signals are no longer available. When electric machines of this kind are used, for example, in the field of electrohydraulic or electromechanical wheel brakes for motor vehicles, it may be required, for example, for the wheel brake to continue to remain functional even in the event of a failure of a sensor signal, or to fall into a fallback level ("RFE"), if it is no longer possible to determine the rotor position or the rotor orientation due to faulty or absent sensor signals.

Here, in the case of a brake system for example, failure of the motor may result in the brake actuation no longer following a driver braking demand, which should be avoided as far as possible. Current measures therefore provide for the permitted driver demands to be limited to such an extent that stable external conditions are created and maximum permitted demands are present such that the rotor can safely follow the rotating field and the specified safety requirements can thus be met. The performance and availability of the brake system that can be achieved in this way can, however, be very limited by the necessary observance of all "worst case" tolerances and the resulting restrictions.

Accordingly, a method for controlling an electronically commutated electric machine which at least mitigates, or does not have, the above-mentioned difficulties is desirable.

### SUMMARY

This object is achieved by means of a method for controlling a brake system of a motor vehicle, a linear actuator, and a brake system for a motor vehicle as described herein.

A first aspect accordingly comprises a method for controlling a brake system of a motor vehicle, comprising at least one hydraulic brake control circuit and at least one electronically commutated electric machine having a rotor and a stator, having the following steps, for example, in the order shown below:

controlling the electric machine by means of a control device in a normal operating mode, wherein the current rotor position is determined by means of a rotor position sensor,

checking the functionality of the rotor position sensor,

upon detection of a sensor error of the rotor position sensor

checking whether a first test condition is met,

if the first test condition is met, changing the controlling of the brake system from the normal operating mode into a safety operating mode and controlling the brake system by means of the control device in the safety operating mode,

in the safety operating mode, checking whether a second test condition is met,

if the second test condition is met, further controlling the brake system by means of the control device in the safety operating mode,

if the second test condition cannot be met or is not met: changing the controlling of the brake system to a fallback operating mode , and

controlling the brake system by means of the control device in the fallback operating mode.

In the present case, the brake system can comprise at least one electrohydraulic vehicle brake system with at least one hydraulic brake control circuit. The hydraulic brake control circuit can include wheel brakes which can be controlled and actuated hydraulically. This does not imply the fact that an electromechanical vehicle brake system with electromechanically actuatable wheel brakes, for example designed as an electromechanically actuatable disk brake, may also be integrated into the brake system. Here, according to an embodiment, it may be provided that hydraulic actuation of the wheel brakes can be accomplished at least in a fallback level ("RFE") by means of driver intervention. Accordingly, according to one embodiment, the wheel brakes belonging to the hydraulic brake control circuit can be actuated electromechanically or electrohydraulically in a normal operating mode, which can correspond to a normal operating mode, and hydraulically in a fallback level.

In an embodiment, the electrohydraulic vehicle brake system may comprise an electrical pressure supply device as a pump assembly, wherein the pressure build-up may be performed by means of the electric machine. For example, the electrical pressure supply device comprises an electronically commutated electric machine with three-phase, electronically commutable, permanently excited and brushless electric motor which can be driven by means of a current-regulated, rotating magnetic field generated by means of a three-phase current. In this context, the motor torque-generating current can also be calculated from the output motor torque. The electric machine comprises, for example, a permanently magnetically excited rotor and an electromagnetically excitable stator. In this case, the rotor is a rotatably mounted element of the electric machine which is set in rotation by the action of the magnetic field of the stator. Such an electric machine is also known as a so-called permanent magnet synchronous machine.

In a normal operating mode of the brake system, the pressure can be built up by the electric machine. In the fallback level, referred to as fallback operating mode, the pressure can be built up without electrical assistance, for example by virtue of a brake pedal being hydraulically connected to the wheel brakes and the pressure being built up by the driver or the force of the driver foot, which is also referred to as driver intervention. Known brake systems can provide that, in the event of a fault in the electrical system, the brake system is moved directly into this hydraulic fallback level in which continued operation of the brake system without electrical assistance occurs.

In order to increase the availability and the possible performance of the brake system, it is proposed that a further operating mode be introduced in which the brake system can be operated. In this operating mode, also referred to as safety operating mode, further electrical assistance of the electric machine for pressure build-up may be provided, although certain limitations or restrictions can be implemented in the safety operating mode. As soon as these predetermined limitations are reached or exceeded, the activation of the brake system can then be transferred into the fallback level or into the fallback operating mode.

Here, controlling the brake system in a normal operating mode may provide for the electric machine to be actuated by a control device in order, for example, to build up a brake pressure, wherein the current rotor position is determined in a known manner by means of a rotor position sensor.

For this purpose, the control device can receive electrical controlling signals which represent a driver braking demand or a braking request by a control unit or a central vehicle computer.

According to an embodiment, it may be provided that during normal operation of the brake system the functionality of the rotor position sensor is checked, for example by corresponding functional units in the control device. In this context, it is possible to check whether a signal of the rotor position sensor is missing or whether a signal of the rotor position sensor is erroneous and/or lies outside predefined limit values. It is furthermore possible to check whether at least one signal of the rotor position sensor is implausible or whether the signals with respect to one another are implausible, for example by means of radius monitoring in the case of the measured sine or cosine signals. In addition, it is possible to check whether the signal transmission is error-free or faulty, for example by means of checksums in the digital signal transmission. A lack of functionality of the rotor position sensor can be referred to as a sensor fault.

If no sensor fault has been observed, the controlling of the brake system in the normal operating mode can be continued without restrictions.

According to an embodiment, when a sensor fault is detected, it is possible to check whether at least one first test condition is met. The first test condition here can comprise one or more tests. Insofar as the first test condition comprises only one test, this can be understood to mean that the first test condition is met if this one test is satisfied. In the case of several tests within the scope of the first test condition, this can be understood to mean that at least one or all of the tests are performed so that the first test condition is met. This can likewise be carried out, for example, by a functional unit of the control device.

If a sensor fault is detected, it is first of all possible to check whether system states are present with respect to the brake system as such or with respect to the electric machine which prevent the control from being changed to a corresponding limited operating mode of the electric machine or into the safety operating mode.

According to an embodiment, the first test condition may comprise checking whether there is a sufficient brake fluid volume in the closedhydraulic brake control circuit to be able to build up the reduced maximum brake pressure. If there is a sufficient brake fluid volume, this test can be considered to be met, otherwise it can be regarded as not met.

According to an embodiment, it is additionally possible to check whether the protection of the system is ensured or whether the system is in a state where a transition to the safety operating mode is not useful because a different system reaction should take place to protect the system. Therefore, for example, in order to protect the electric machine in a case in which a reference travel for zero-point detection occurs and/or the machine is moved at high speed in the direction of the rear stop, switching over to the safety operating mode could be unfavorable. If the protection of the system is ensured, this test can be considered to be fulfilled and otherwise not satisfied.

According to an embodiment, the first test condition can accordingly be assessed as met if both of the above mentioned tests are satisfied. If the first test condition is met, changing the control of the brake system from the normal operating mode into a safety operating mode and controlling the brake system in the safety operating mode by the control device can take place. If the first test condition is not met or does not permit operation in the safety operating mode, the controlling of the brake system can be immediately changed to a fallback operating mode and the brake system can be controlled by the control device in the fallback operating mode.

According to an embodiment, the safety operating mode can comprise sensorless operation, also referred to as specification-controlled three-phase operation. This means that the electric machine of the brake system can continue to be actuated, for example for generating pressure, but without a sensor. In other words, by means of the control device, a rotating field can be created which can be followed by the rotor of the electric machine. The rotating field can be generated with a limited phase current in this case. For this purpose, read-in current values can be used.

In order to be able to maintain the safety operating mode as safely and for as long as possible, according to an embodiment, the safety operating mode can be implemented as a limited normal operating mode. This means that, compared with the normal operating mode, the safety operating mode can allow fewer functions and/or fewer methods and/or narrower operating windows.

Thus, according to an embodiment, there can be provision that, with respect to the control of the electric machine, at least one of the following restrictions is implemented for the operation of the electric machine in the safety operating mode:

the rotational speed is restricted to a predefined rotational speed limit value,

the torque is restricted to a predefined torque limit value,

the acceleration is restricted to a predefined acceleration limit value,

the efficiency is reduced.

Furthermore, in an exemplary embodiment, the control of the brake system may also be subject to restrictions. Therefore, provision can be made for at least one of the following restrictions to be implemented for the controlling of the brake system in the safety operating mode:

the brake pressure is reduced to a predefined brake pressure limit value,

the pressure gradient is reduced to a predefined pressure gradient limit value,

the increase of the pressure gradient is reduced to a predefined pressure gradient limit value.

In this case, the restrictions are set in such a way that no safety-relevant requirements are violated.

The above-mentioned limit values may for example be stored in a memory of the control device and constitute limit and maximum values to be complied with. If, for example, a vehicle driver specifies a braking demand in the case of which the control of the electric machine for building up pressure specifies a rotational speed which is above the predefined rotational speed limiting value, said requested rotational speed can be reduced to the predefined rotational speed limit value by the control device. This can have the result that the efficiency is reduced.

In order to ensure that the driver request can continue to be implemented in the safety operating mode as well, it is provided, according to an embodiment, that the operation of the brake system in the safety operating mode is monitored with suitable means. This is intended to exclude possible abnormal behavior of the brake system. When an imminent abnormal behavior or an abnormal behavior of the brake system is detected, provision is therefore made for the controlling to be able to be switched to a further, reliably available fallback level. Further controlling of the brake system by the control device can then be carried out in the fallback operating mode.

According to an embodiment, as long as the desired delay is achieved or the safety-relevant requirements are met, the safety operating mode can be maintained.

According to another embodiment, provision is therefore made for a check to be carried out in the safety operating mode to determine whether a further, second test condition is met. If the second test condition is met, further controlling of the brake system can be carried out by the control device in the safety operating mode, that is to say controlling in the safety operating mode can be maintained.

If the second test condition cannot be met, it is possible, according to an embodiment, to transfer the control of the brake system into the fallback operating mode in order to be able to reliably exclude an abnormal behavior of the brake system.

The second test condition can comprise one or more tests. Insofar as the second test condition comprises only one test, this can be understood to mean that the second test condition is met if this one test is satisfied. In the case of multiple tests within the scope of the second test condition, this can be understood to mean that at least one or multiple or all of the tests are performed so that the second test condition is met.

According to an embodiment, the second test condition may comprise checking whether the requested brake pressure or the brake pressure reduced in accordance with the restrictions can be set. In this context, brake pressure means a pressure which correlates with a contact pressure with which friction pads of a wheel brake are pressed against a counterfriction element in order to generate a predetermined braking torque. The counterfriction element may for example comprise a brake disk in the case of a wheel brake designed as a disk brake, against which brake disk the friction pads can be pressed in order to impart a braking torque.

If a braking demand is provided, this can lead to the electric machine, as pressure generator, generating the corresponding pressure in the hydraulic brake circuit in order to be able to provide the corresponding braking torque. Due to the restrictions in the controlling or the electric machine, the situation may occur in which this braking demand cannot be implemented in the safety operating mode since the corresponding pressure cannot be applied due to the motor limitation. In this case, the demanded brake pressure cannot be provided and the brake system can be put into the fallback operating mode. This test within the second test condition can therefore be regarded as not met.

The second test condition may comprise further tests. These tests within the second test condition can be used alternatively or additionally. These may include: comparing the requested brake pressure with the corresponding brake pressure in the hydraulic system or the contact pressure force of the friction pads. If the pressure in the hydraulic system, which can be obtained, for example, by means of a pressure sensor or pressure measuring instrument, at least corresponds to the driver braking demand, the safety operating mode can continue to be maintained. The contact pressure force of the friction pads can be obtained, for example, by means of force sensors.

A further check may be directed to whether the time until the required brake pressure or the required contact force is reached takes place within a predetermined time limit value.

A yet further check can be directed toward whether the current wheel deceleration of at least one wheel coincides with the demanded vehicle deceleration. This can be used, for example, in conjunction with electromechanically actuatable wheel brakes when no hydraulic system is used in the safety operating mode and therefore no sensor for measuring the pressure in the hydraulic system.

Furthermore, it is possible to check whether the synchronicity of the electric machine is provided. For this purpose, sensor information may be evaluated and it may be checked whether there are indications that indicate that the rotor is not following the rotating field.

For the tests described above, it is assumed that the demanded brake pressures or contact forces, or also wheel decelerations, originate from a vehicle driver. In one development, however, there is also provision that these braking requests can come from superordinate vehicle functions, for example from a vehicle computer. For this purpose, according to a development, it may be provided that the brake system has a separately controllable further brake, for example a separate electromechanically actuatable parking brake (EPB).

The fallback operating mode is an operating mode in which pressure is built up in the brake system without use of an electric machine, for example solely by a hydraulic system. It is assumed here that, in this fallback level, there is driver intervention on the brake system to the extent that the hydraulic system can be coupled to the pedal for detecting the driver braking intention.

Thus it is possible for a moderate driver demand to be comfortably implemented even under restricted boundary conditions in the safety operating mode. If a braking demand, for example the driver braking demand or a braking request by a superordinate control unit or a central vehicle computer, exceeds the performance of the brake system under the current boundary conditions or those specified by the restrictions, the less comfortable fallback level is automatically reached, in which the driver braking demand or the braking request can nevertheless be safely implemented.

Thus it is possible, even in the event of a failure of at least one or all of the sensor signals of a rotor position sensor, to continue operating the electronically commutated electric machine of the brake system initially in an only slightly or correspondingly restricted safety operating mode with safe, sufficient performance until, on account of certain system states of the brake system or of the electric machine which require continued operation in this safety operating mode, the controlling takes place in a fallback level or in a fallback operating mode.

Here, by means of the method, influencing variables which may change during the operation of the brake system can also be taken into account for the selection of the control method. These may include, for example:

temperature changes due to increased friction,

a limited battery usage requested by a superordinate vehicle system,

an electric current limitation requested by a superordinate vehicle system,

an undervoltage,

vibrations or external influences.

According to an embodiment, the checking of the functionality of the rotor position sensor and/or the checking of the first and/or of the second test condition during operation of the brake system may be carried out in very short time cycles in order to ensure the shortest possible reaction time.

The rotor position sensor can comprise an optical, inductive, capacitive or magnetic measuring principle.

Included in a further aspect is a brake system of a motor vehicle, designed to carry out a method as explained above.

Further details will emerge from the description of the illustrated exemplary embodiments and from the appended claims.

### BRIEF DESCRIPTION OF THE DRAWINGS

In the drawings:

FIG. 1 shows a flow diagram for the method.

### DETAILED DESCRIPTION

A first aspect comprises a method for controlling a brake system of a motor vehicle, comprising at least one hydraulic brake control circuit and at least one electronically commutated electric machine having a rotor and a stator.

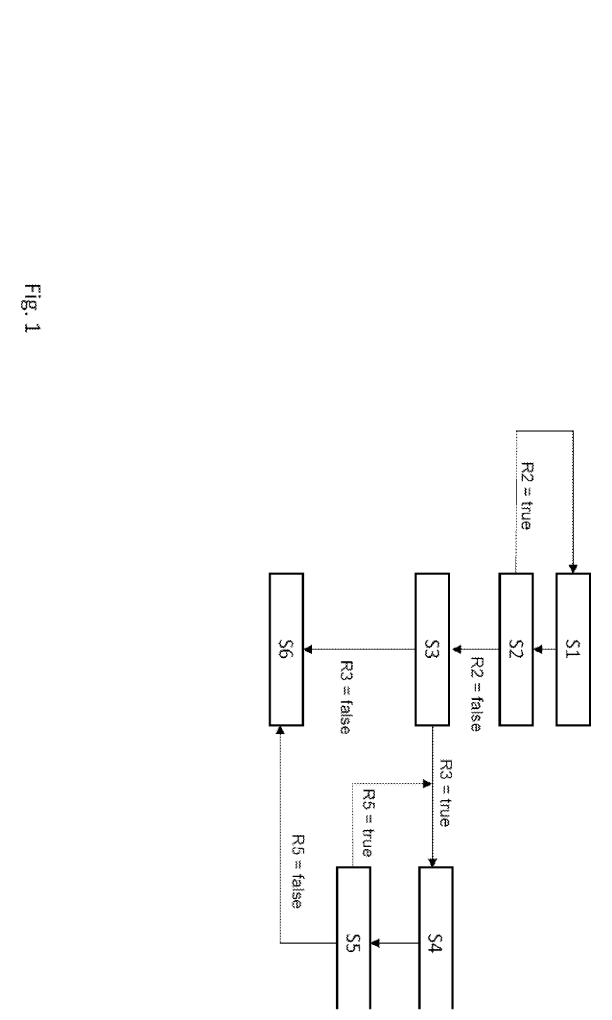

A flow diagram for this is specified in FIG. 1. The method comprises:

controlling the electric machine by means of a control device in a normal operating mode in a step S1, wherein the current rotor position is determined by means of a rotor position sensor,

checking the functionality of the rotor position sensor in a step S2,

upon detection of a sensor error of the rotor position sensor

in a step S3, checking whether a first test condition is met

if the first test condition is met, changing the controlling of the brake system from the normal operating mode into a safety operating mode, and controlling the brake system in the safety operating mode by the control device in step S4,

in the safety operating mode, checking whether a second test condition is met, in step S5,

if the second test condition is met, further controlling the brake system by means of the control device in the safety operating mode according to step S4,

if the second test condition cannot be met or is not met: changing the controlling of the brake system to a fallback operating mode in step S6, and

controlling the brake system by the control device in the fallback operating mode according to step S6.

According to an exemplary embodiment, the brake system comprises an electrohydraulic vehicle brake system with at least one hydraulic brake control circuit. The hydraulic brake control circuit includes wheel brakes which can be controlled and actuated hydraulically. According to an exemplary embodiment, it is provided here that hydraulic actuation of the wheel brakes can be performed, at least in a fallback level ("RFE"), by means of driver intervention. The wheel brakes belonging to the hydraulic brake control circuit can be actuated electromechanically or electrohydraulically in a normal operating mode, and hydraulically in a fallback level.

In an exemplary embodiment, the electrohydraulic vehicle brake system comprises an electrical pressure supply device as a pump assembly, wherein the pressure build-up is performed by means of the electric machine. The electrical pressure supply device comprises an electronically commutated electric machine with three-phase, electronically commutable, permanently excited and brushless electric motor which can be driven by means of a current-regulated, rotating magnetic field generated by means of a three-phase current. The electric machine comprises, for example, a permanently magnetically excited rotor and an electromagnetically excitable stator.

In a normal operating mode of the brake system, according to an exemplary embodiment, the pressure can be built up by the electric machine. In the fall-back level, the pressure build-up may take place without electrical assistance by virtue of the fact that a brake pedal is hydraulically connected to the wheel brakes and the pressure build-up is effected by the driver or the driver foot force.

Here, controlling the brake system in a normal operating mode in step S1 provides for the electric machine to be controlled by the control device in order, for example, to build up a brake pressure, wherein the current rotor position is determined in a known manner by means of a rotor position sensor. For this purpose, the control device receives electrical controlling signals which represent a driver braking demand or a braking request by a control unit or a central vehicle computer.

According to an exemplary embodiment, the functionality of the rotor position sensor is checked in a step S2 during normal operation of the brake system by corresponding functional units in the control device. In this context, according to an exemplary embodiment, it is checked whether a signal of the rotor position sensor is missing or whether a signal of the rotor position sensor is faulty and/or lies outside predefined limit values. Furthermore, according to an exemplary embodiment, a check is carried out as to whether at least one signal of the rotor position sensor is implausible or the signals are implausible with respect to one another. Known methods for monitoring radii are applied for this purpose for the measured sine or cosine signals. In addition, it is checked whether the signal transmission is error-free or faulty, for example by means of checksums in the digital signal transmission. A lack of functionality of the rotor position sensor is referred to as a sensor fault. According to an exemplary embodiment, a sensor fault is processed in the control by setting a signal R2 = false. If there is no sensor fault (R2 = true), further controlling in the normal operating mode is carried out in accordance with an exemplary embodiment.

After detection of a sensor fault (R2 = false), a check is made in a step S3 to determine whether at least one first test condition is met.

According to an exemplary embodiment, the first test condition comprises one or more checks.

According to an exemplary embodiment, during the first check it is checked whether there is a sufficient brake fluid volume in the closed hydraulic brake control circuit to be able to build up the reduced maximum brake pressure. If there is a sufficient brake fluid volume, this test can be considered to be met (R3 = true) otherwise it can be regarded as not met (R3 = false).

According to an exemplary embodiment, a check is made as to whether protection of the brake system is guaranteed or whether the brake system is in a state where a transition to the safety operating mode is not appropriate because a different system reaction should take place to protect the brake system. According to an exemplary embodiment, the safety operating mode is not considered to be useful (R3 = false) if a reference travel for zero-point detection is currently taking place and/or the machine is being moved at high speed in the direction of the rear stop.

The safety operating mode in step S4 means sensorless operation, also referred to as specification-controlled three-phase operation, wherein the electric machine of the brake system can still be controlled, for example for generating pressure, but without sensors. The safety mode is implemented as a restricted normal operating mode.

In this case, at least one of the following restrictions for the operation of the electric machine in the safety operating mode is implemented for the operation of the electric machine:

the rotational speed is restricted to a predefined rotational speed limit value,

the torque is restricted to a predefined torque limit value,

the acceleration is restricted to a predefined acceleration limit value,

the efficiency is reduced.

Furthermore, the control of the braking system is also subject to restrictions, wherein at least one of the following restrictions is implemented:

the brake pressure is reduced to a predefined brake pressure limit value,

the pressure gradient is reduced to a predefined pressure gradient limit value,

the increase of the pressure gradient is reduced to a predefined pressure gradient limit value.

One exemplary embodiment provides for a check to be performed in the safety operating mode in a step S5 to determine whether a further, second test condition has been met. If the second test condition is met (R5 = true), further controlling the brake system by means of the control device in the safety operating mode takes place. If the second test condition cannot be met (R5 = false), according to an exemplary embodiment, the controlling of the brake system is switched into the fallback operating mode in order to be able to reliably exclude an abnormal behavior of the brake system.

The second test condition comprises one or more checks.

Here, according to an exemplary embodiment, the second test condition comprises checking whether the demanded brake pressure or the brake pressure reduced in accordance with the restrictions can be set. If the demanded brake pressure cannot be provided (R5 = false), the control is placed into the fallback operating mode, step S6.

According to an exemplary embodiment, the second test condition comprises comparing the demanded brake pressure with the corresponding brake pressure in the hydraulic system or the contact pressure force of the friction pads. If the pressure in the hydraulic system, which can be obtained, for example, by means of a pressure sensor or pressure measuring instrument, at least corresponds to the driver braking demand, the safety operating mode can continue to be maintained (R5 = true).

A further possible check is directed to whether the time until the required brake pressure or the required contact force is reached is within a predetermined time limit value. If this is the case, the safety operating mode can be further maintained (R5 = true).

A yet further possible check is directed toward whether the current wheel deceleration of at least one wheel coincides with the demanded vehicle deceleration. This can be used, for example, in conjunction with electromechanically actuatable wheel brakes when no hydraulic system is used in the safety operating mode and therefore no sensor for measuring the pressure in the hydraulic system. In the event of concordance, the safety operating mode can continue to be maintained (R5 = true).

A yet further possible check is directed to whether synchronicity of the electric machine is provided. For this purpose, sensor information may be evaluated and it may be checked whether there are indications that indicate that the rotor is not following the rotating field. If it is detected that the rotor no longer follows the rotating field (R5 = false), the safety operating mode can be terminated and a change can be made to the fallback operating mode in step S6.

The fallback operating mode according to step S6 represents an operating mode in which pressure is built up in the brake system without recourse to an electric machine, for example solely by means of a hydraulic system. According to an exemplary embodiment, the driver intervenes here on the brake system to the extent that the hydraulic system is coupled to the pedal for detecting the driver braking intention.

The testing of the functionality of the rotor position sensor and/or the testing of the first and/or the second test condition during operation of the brake system is performed here in very short time cycles.

Another embodiment provides for the query in step S3 to be skipped and for this check to be performed only in step S5. The method according to this embodiment then has the following steps:

controlling the electric machine by means of a control device in a normal operating mode in a step S1, wherein the current rotor position is determined by means of a rotor position sensor,

checking the functionality of the rotor position sensor in a step S2,

upon detection of a sensor error of the rotor position sensor

changing the controlling of the brake system from the normal operating mode into a safety operating mode, and controlling the brake system in the safety operating mode by the control device in step S4,

in the safety operating mode, checking whether a first test condition is being met, in a step S3, and checking whether a second test condition is being complied with, in a step S5,

if the first and/or second test condition is met, further controlling the brake system by means of the control device in the safety operating mode according to step S4,

if the first and/or second test condition cannot be met or is not met: changing the controlling of the brake system to a fallback operating mode in step S6, and

controlling the brake system by the control device in the fallback operating mode according to step S6.

The steps S3 and S5 are therefore performed together in a method step after the control device has been switched into the safety operating mode.

The test conditions for example remain unchanged.

This allows simpler implementation of the queries to be achieved. It is disadvantageous that the safety operating mode is possibly switched unnecessarily in this method. On account of the short time cycles in the range of a few milliseconds, however, this disadvantage is considered acceptable.

The rotor position sensor comprises an optical, inductive, capacitive or magnetic measuring system.

Also comprised by the embodiments is a brake system of a motor vehicle, designed to carry out a method as described above.

1. A method for controlling a brake system of a motor vehicle comprising:
controlling an electric machine with a control device in a normal operating mode, wherein a current rotor position of the electric machine is determined using a rotor position sensor;
checking the functionality of the rotor position sensor;
checking whether a first test condition is met upon detection of a sensor error of the rotor position sensor;
changing the controlling of the brake system from the normal operating mode into a safety operating mode when the first test condition is met;
controlling the brake system with the control device in the safety operating mode;
checking whether a second test condition is met in the safety operating mode;
controlling the brake system further with the control device in the safety operating mode when the second test condition is met;
changing the controlling of the brake system to a fallback operating mode when the second test condition is not met; and
controlling the brake system with the control device in the fallback operating mode.

2. The method according to claim 1, wherein the controlling of the electric machine in the normal operating mode is performed on the basis of electrical control signals which represent a driver braking demand or a braking request by a superordinate control unit.

3. The method according to claim 1, wherein the checking of the functionality of the rotor position sensor comprises at least one of:
checking whether a signal of the rotor position sensor is missing;
checking whether a signal of the rotor position sensor is erroneous;
checking whether a signal of the rotor position sensor lies outside predefined limit values;
checking whether at least one signal of the rotor position sensor is implausible;
checking whether at least one signal of the rotor position sensor is implausible with respect to another of the at least one signal of the rotor position sensor; and
checking whether the signal transmission is fault-free or faulty.

4. The method according to claim 1, wherein the first test condition comprises at least one of:
checking whether there is a sufficient brake fluid volume in the closed hydraulic brake control circuit; and
checking whether the protection of the system is guaranteed.

5. The method according to claim 1, wherein the safety operating mode comprises a sensorless three-phase operation, in which the electric machine of the brake system can continue to be controlled.

6. The method according to claim 1, wherein the safety operating mode comprises a limited normal operating mode, in which at least one of the following restrictions for operation of the electric machine is implemented:
restricting the rotational speed to a predefined rotational speed limit value;
restricting the torque to a predefined torque limit value;
restricting the acceleration to a predefined acceleration limit value; and
reducing the efficiency.

7. The method according to claim 1, wherein the safety operating mode comprises a limited normal operating mode, in which at least one of the following restrictions for controlling the brake system is implemented:
reducing the brake pressure to a predefined brake pressure limit value;
reducing the pressure gradient to a predefined pressure gradient limit value; and
reducing the increase of the pressure gradient to a predefined pressure gradient limit value.

8. The method according to claim 1, wherein the second test condition comprises at least one of:
checking whether the required brake pressure can be set;
comparing the demanded brake pressure with corresponding brake pressure
time until the required brake pressure or the required contact force is reached;
comparing the current wheel deceleration of at least one wheel with the required vehicle deceleration; and
checking whether there is synchronicity between rotor and rotating stator field of the electric machine.

9. The method according to claim 1, wherein the fallback operating mode comprises an operating mode in which pressure is built up without recourse to an electric machine by a hydraulic system by driver braking force.

10. The method according to claim 9, wherein in the fallback operating mode, the hydraulic system is coupled to the pedal for detecting the driver braking demand.

11. The method according to claim 1, wherein at least one of the checking of the functionality of the rotor position sensor, the checking of the first test condition, and the checking of the second test condition occurs in very short time cycles during the operation of the brake system.

12. The method according to claim 1, wherein the rotor position sensor comprises one of an optical, inductive, capacitive and magnetic measuring system.

13. A brake system of a motor vehicle comprising:
an electric machine having a rotor and a rotor position sensor;
a control unit having instructions for:
controlling the electric machine in a normal operating mode, wherein a current rotor position of the electric machine is determined using the rotor position sensor;
checking the functionality of the rotor position sensor;
checking whether a first test condition is met upon detection of a sensor error of the rotor position sensor;
changing the controlling of the brake system from the normal operating mode into a safety operating mode when the first test condition is met;
controlling the brake system with the control device in the safety operating mode;
checking whether a second test condition is met in the safety operating mode;
controlling the brake system further with the control device in the safety operating mode when the second test condition is met;
changing the controlling of the brake system to a fallback operating mode when the second test condition is not met; and
controlling the brake system with the control device in the fallback operating mode.
